(19) United States
(12) Patent Application Publication
(10) Pub. No.: US 2009/0070581 A1
(43) Pub. Date: Mar. 12, 2009

(54) SYSTEM AND METHOD FOR CENTRALIZED USER IDENTIFICATION FOR NETWORKED DOCUMENT PROCESSING DEVICES

(76) Inventors: Amir SHAHINDOUST, Laguna Niguel, CA (US); Sameer Yami, Irvine, CA (US); Peter HN Tran, Garden Grove, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/851,144

(22) Filed: Sep. 6, 2007

(51) Int. Cl. H04L 9/32

(52) U.S. Cl. 713/168

(57) ABSTRACT

The subject application is directed to a system and method for centralized user identification for networked document processing devices. A secure communications channel is first established between a document processing device designated as an authentication device and at least one additional document processing device of a plurality of document processing devices. The authentication device then communicates address data to each additional document processing device. Credential data associated with a user of a document processing device is then received. The received credential data is communicated from the document processing device to the authentication device. The user of the document processing is then authenticated in accordance with the received credential data. Authorization data representing the authorization of the user to perform a document processing operation on the document processing device is then communicated to the document processing device from the authentication device according to the completed authentication of the user.

### BACKGROUND OF THE INVENTION

The subject application is directed generally to secure use of document processing devices. The application is particularly applicable to secure use of networked office document processing machines in simple and inexpensively maintained environments.

Document processing devices included copiers, printers, facsimile machines, electronic mail clients, scanners, plotters and the like. Many current document processing devices include more than one function, and are referred to as multifunction peripherals or MFPs.

Many operations of document processing devices, particularly in networked or shared devices, result in a transmission of confidential information. By way of example, payroll information, salary information, or any other confidential information may be sent for printing, storage, or other type of transmission. When such information is communicated from a user's device to a shared or networked peripheral, there is a risk that the data may be intercepted or otherwise made available to an unauthorized party. To alleviate the foregoing concerns, many networked or shared peripheral systems will employ secure transmission and authorization schemes to maintain document security.

Many current systems require a dedicated, centralized server or groups of servers to store authentication information for a network of users. In addition to adding expense and complexity to secure document processing systems, there is an administrative burden to assure that user information is entered into the centralized system and maintained properly.

Another option is that each document processing device, such as an MFP, maintains its own authentication system. While this may work effectively for very small locations, it becomes unwieldy when information must be independently loaded into more than a few devices. An earlier solution is to clone information and transport it between devices. However, information may be outdated frequently, requiring regular cloning operations

### SUMMARY OF THE INVENTION

In accordance with one embodiment of the subject application, there is provided a system and method for secure use of document processing devices.

Further, in accordance with one embodiment of the subject application, there is provided a system and method for secure use of networked office document processing machines in simple and inexpensively maintained environments.

Further, in accordance with one embodiment of the subject application, there is provided a system for centralized user identification system for networked document processing devices. The system includes a plurality of document processing devices, each document processing device including a controller having at least one document rendering device associated therewith, and wherein one document processing device is designated as an authentication device. The system further includes securing means adapted for establishing a secure data communication channel between the authentication device and at least one additional document processing device of the plurality thereof and means adapted for communicating address data associated with the authentication device to each at least one additional document processing device. The system also includes means adapted for receiving credential data associated with a user of the at least one document processing device and means adapted for communicating received credential data from the at least one document processing device to the authentication device in accordance with address data. The system also comprises authentication means adapted for authenticating the user of the at least one document processing device in accordance with received credential data and means adapted for communicating authorization data representative of authorization of the user to perform at least one document processing operation on the at least one document processing device in accordance with a completed authentication from the authentication device to the at least one document processing device.

In one embodiment of the subject application, the securing means also includes means adapted for generating a self-signed certificate on the at least one additional document processing device and means adapted for publishing a generated certificate to the authentication device.

In another embodiment of the subject application, the authentication means includes means adapted for receiving user key data from the user and means adapted for encrypting received user key data with a public key associated with the authentication means. The authentication means further includes storage means adapted for storing encrypted user key data and testing means adapted for testing credential data against encrypted user key data disposed in the storage means in accordance with an authentication. In a preferred embodiment, the storage means is comprised of an LDAP server.

In a further embodiment of the subject application, the address data is comprised of at least one of the group consisting of an IP address and a URL associated with the authentication device.

In yet another embodiment of the subject application, the credential data is received from at least one device from a set comprising a workstation, a smart phone, and a personal digital assistant. The credential data is communicated via at least one of a wireless and wired communication medium.

Still further, in accordance with one embodiment of the subject application, there is provided a method for centralized user identification for networked document processing devices in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a centralized user identification system for networked document processing devices according to one embodiment of the subject application;

FIG. 2 is a block diagram illustrating controller hardware for use in the centralized user identification system for networked document processing devices according to one embodiment of the subject application;

FIG. 3 is a functional diagram illustrating the controller for use in the centralized user identification system for networked document processing devices according to one embodiment of the subject application;

FIG. 4 is a flowchart illustrating a method for centralized user identification for s networked document processing devices according to one embodiment of the subject application; and

FIG. 5 is a flowchart illustrating a method for centralized user identification for networked document processing devices according to one embodiment of the subject application.

### DETAILED DESCRIPTION OF THE PREFERRED EMBODIMENT

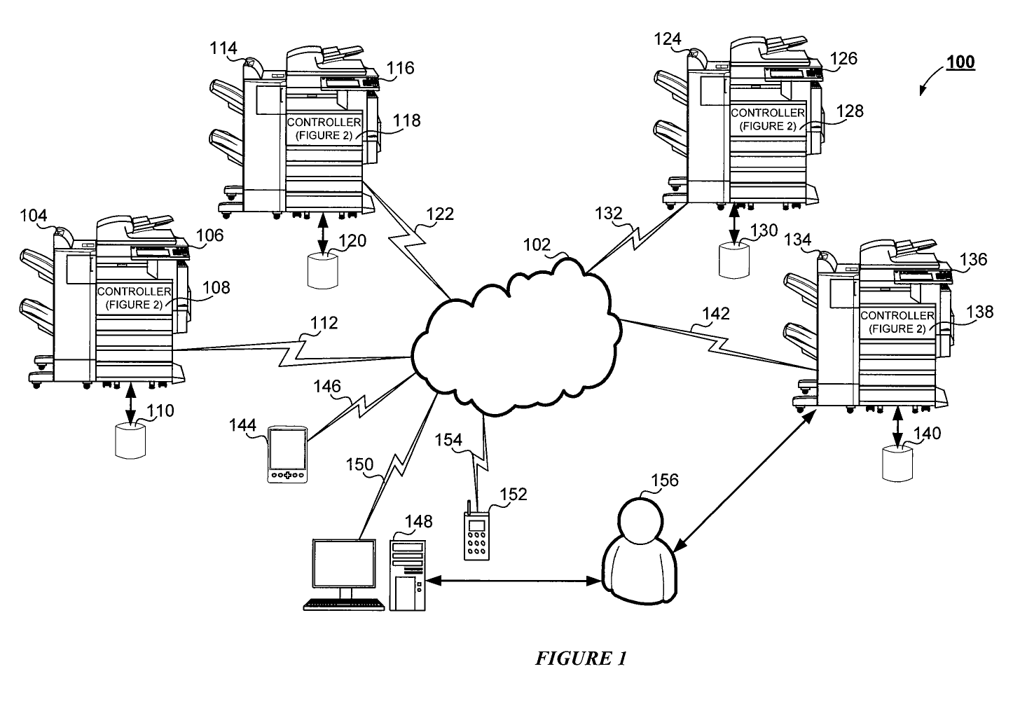

The subject application is directed to a system and method for secure use of document processing devices. In particular, the subject application is directed to a system and method for secure use of networked office document processing machines in simple and inexpensively maintained environments. It will become apparent to those skilled in the art that the system and method described herein are suitably adapted to a plurality of varying electronic fields employing device authentication, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a centralized user identification system 100 for networked document processing devices in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a plurality of document processing devices, shown in FIG. 1 as a first document processing device 104, a second document processing device 114, a third document processing device 124, and a fourth document processing device 134. Use of the four document processing devices 104, 114, 124, and 134 is for example purposes only, and the skilled artisan will appreciate that any number of additional document processing devices is capable of being implemented in accordance with the subject application. The document processing devices 104, 114, 124, and 134 are depicted in FIG. 1 as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104 are suitably adapted to provide remote document processing services to external or network devices. Thus, the skilled artisan will appreciate that the document processing devices 104, 114, 124, and 134 include hardware, software, and any suitable combination thereof, configured to interact with an associated user, a networked device, or the like. With respect to a preferred embodiment, one of the document processing devices 104, 114, 124, or 134, is suitably configured to function as an authenticating authority, e.g., an authentication server or central device, to facilitate the authentication of users 156 of the document processing devices 104, 114, 124, and 134, via the computer network 102. For purposes of illustrating one embodiment of the subject application, the first document processing device 104 is designated as the authenticating document processing device for users 156 of the computer network 102.

According to one embodiment of the subject application, the document processing devices 104, 114, 124, and 134 are suitably equipped to receive a plurality of portable storage media, including, without limitation, Firewire drive, USB drive, SD, MMC, XD, Compact Flash, Memory Stick, and the like. In the preferred embodiment of the subject application, each of the document processing devices 104, 114, 124, and 134 further include an associated user interface 106, 116, 126, and 136, such as a touch-screen, LCD display, touch-panel, alpha-numeric keypad, or the like, via which an associated user 156 is able to interact directly with the respective document processing devices 104, 114, 124, and 134. In accordance with the preferred embodiment of the subject application, the user interfaces 106, 116, 126, and 136 are advantageously used to communicate information to the associated user 156 and receive selections from the associated user 156. The skilled artisan will appreciate that the user interfaces 106, 116, 126, and 136 comprise various components, suitably adapted to present data to the associated user 156, as are known in the art. In accordance with one embodiment of the subject application, the user interfaces 106, 116, 126, and 136 each comprise a display, suitably adapted to display one or more graphical elements, text data, images, or the like, to the associated user 156, receive input from the associated user 156, and communicate the same to a backend component, such as a controller 108, 118, 128, or 138, respectively, as explained in greater detail below. Preferably, the document processing devices 104, 114, 124, and 134 are communicatively coupled to the computer network 102 via suitable corresponding communications links 112, 122, 132, and 142. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

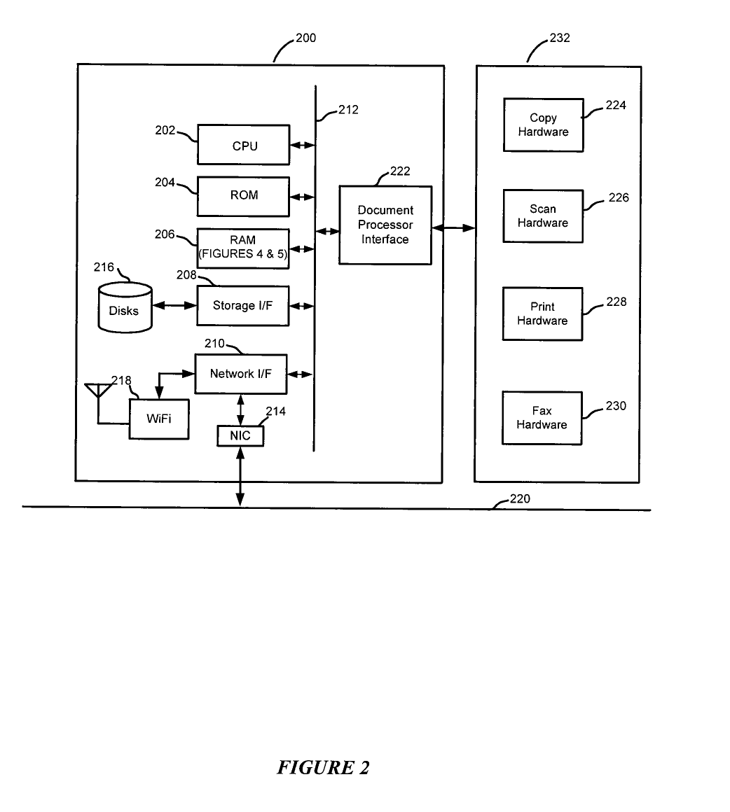

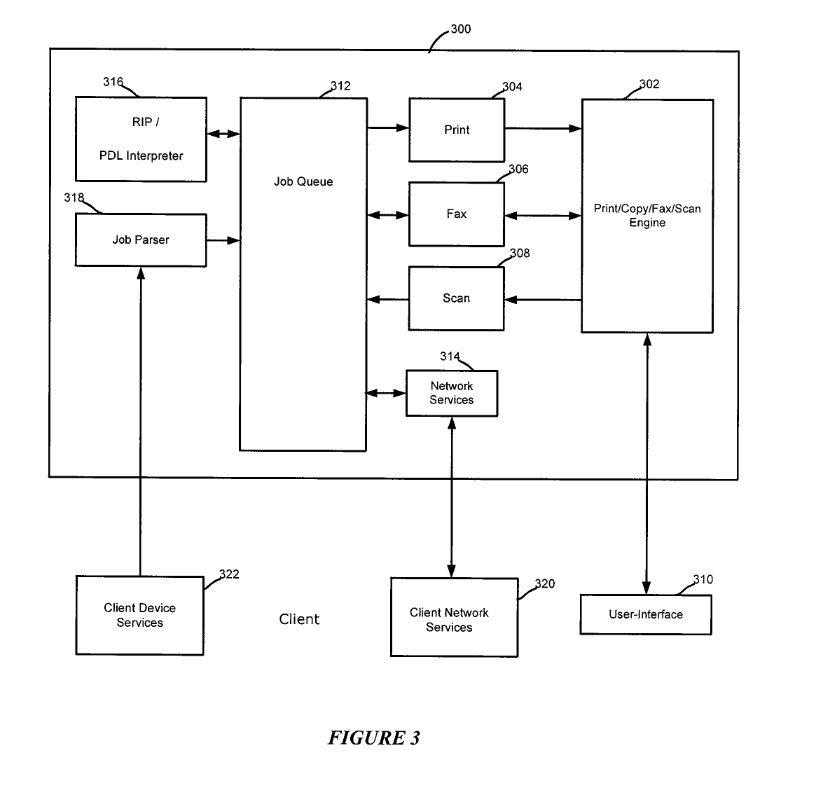

In accordance with one embodiment of the subject application, the document processing devices 104, 114, 124, and 134 further incorporate a backend component, designated, respectively, as the controllers 108, 118, 128, and 138, suitably adapted to facilitate the operations of their respective document processing devices 104, 114, 124, and 134, as will be understood by those skilled in the art. Preferably, the controllers 108, 118, 128, and 138 are embodied as hardware, software, or any suitable combination thereof, configured to control the operations of the corresponding associated document processing device 104, 114, 124, or 134, facilitate the display of images via the respective user interface 106, 116, 126, or 136, direct the manipulation of electronic image data, and the like. For purposes of explanation, the controllers 108, 118, 128, and 138 are used to refer to any myriad of components associated with the document processing devices 104, 114, 124, and 134, respectively, including hardware, software, or combinations thereof, functioning to perform, cause to be performed, control, or otherwise direct the methodologies described hereinafter. It will be understood by those skilled in the art that the methodologies described with respect to the controllers 108, 118, 128, and 138, are capable of being performed by any general purpose computing system, known in the art, and thus the controllers 108, 118, 128, and 138 are representative of such a general computing device and are intended as such when used hereinafter. Furthermore, the use of the controllers 108, 118, 128, and 128 hereinafter is for the example embodiment only, and other embodiments, which will be apparent to one skilled in the art, are capable of employing the system and method for centralized user identification for networked document processing devices of the subject application. The functioning of the controllers 108, 118, 128, and 138 will better be understood in conjunction with the block diagrams illustrated in FIGS. 2 and 3, explained in greater detail below.

Communicatively coupled to the document processing devices 104, 114, 124, and 134 are, respectively, data storage devices 110, 120, 130, and 140. In accordance with the preferred embodiment of the subject application, the data storage devices 110, 120, 130, and 140 are any mass storage devices known in the art including, for example and without limitation, magnetic storage drives, hard disk drives, optical storage devices, flash memory devices, or any suitable combination thereof. In the preferred embodiment, the data storage devices 110, 120, 130, and 140, are suitably adapted to store document data, image data, electronic database data, or the like. It will be appreciated by those skilled in the art that while illustrated in FIG. 1 as being a separate component of the system 100, the data storage devices 110, 120, 130, and 140 are capable of being implemented as internal storage component of a corresponding document processing device 104, 114, 124, or 134, a component of the respective controller 108, 118, 128, or 138, or the like, such as, for example and without limitation, an internal hard disk drive, or the like. In accordance with one embodiment of the subject application, the data storage device 110 associated with the authenticating document processing device 104 includes an electronic database containing electronic data representative of a plurality of users associated with the computer network 102.

The system 100 illustrated in FIG. 1 further depicts a plurality of user devices, in data communication with the computer network 102 and the user 156. As shown in FIG. 1, the user devices include, for example and without limitation, a personal digital assistant 144, a computer workstation 148, and a smart phone 152, each of which is communicatively coupled to the computer network 102 via a corresponding communications link 146, 150, and 154. It will be appreciated by those skilled in the art that the user devices 144, 148, and 152 are shown in FIG. 1, respectively, as a personal digital assistant, a workstation, and a smart phone for illustration purposes only. As will be understood by those skilled in the art, any one of the user devices 144, 148, and 152 is representative of any personal computing device known in the art, including, for example and without limitation, a laptop computer, a computer workstation, a personal computer, a personal data assistant, a web-enabled cellular telephone, a smart phone, a proprietary network device, or other web-enabled electronic device. The communications links 146, 150, and 154 are any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user devices 144, 148, and 152 are suitably adapted to generate and transmit electronic documents, document processing instructions, user identification data, user encryption keys, personalization data, or the like, to the document processing devices 104, 114, 124, and 134, or any other similar device coupled to the computer network 102.

Turning now to FIG. 2, illustrated is a representative architecture of a suitable backend component, i.e., the controller 200, shown in FIG. 1 as the controllers 108, 118, 128, and 128, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controllers 108, 118, 128, and 128) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

In operation, a secure communications channel is first established between an authentication device and at least one additional document processing device of a plurality of document processing devices. Each document processing device of the plurality of devices includes a controller, which has at least one document rendering device associated therewith. One of the document processing devices is designated as the authentication device. Address data associated with the authentication device is then communicated to each at least one additional document processing device. Credential data associated with a user of the at least one document processing device is then received. The received credential data is then communicated from the at least one document processing device to the authentication device in accordance with the address data. The user of the at least one document processing is then authenticated in accordance with the received credential data. Authorization data representing the authorization of the user to perform a document processing operation on the at least one document processing device is then communicated to the at least one document processing device from the authentication device according to the completed authentication of the user.

In accordance with one example embodiment of the subject application, a secure communications channel is established between an authentication device, i.e., a designated document processing device on the computer network 102, and at least one additional document processing device 104, 114, 124, or 134. For this example embodiment, the first document processing device 104 is designated as the authentication device. The at least one additional document processing device is designated hereinafter, for example purposes, as the fourth document processing device 134. The fourth document processing device 134 then generates a self-signed certificate, which is published to the authentication device 104 via the computer network 102 over the secure communications channel. For each of the document processing devices 114, 124, and 134, the authentication device 104 communicates its associated address data. According to one embodiment of the subject application, the address data includes, for example and without limitation, a uniform resource locator (URL), an Internet Protocol (IP) address, or the like. The skilled artisan will appreciate that the published certificate is capable of being stored in the data storage device 110 associated with the authentication device 104, for example, within a lightweight directory access protocol (LDAP) server resident thereon.

A user 156, associated with a user device 144, 148, or 152, or directly accessing the fourth document processing device 134, then facilitates the generation of symmetric keys for encryption. The fourth document processing device 134 then receives user key data and encrypts the user symmetric keys using a public key associated with the authentication device 104, which is known to the fourth document processing device 134 in accordance with the received address data. The encrypted key is then communicated to the authentication device 104, whereupon it is stored in the data storage device 110, preferably within an LDAP server resident thereon. When additional users are to be added to the LDAP server, operations continue as set forth above with the receipt of user key data, encryption, and storage.

Upon the receipt of a document processing request from the user 156 via the user interface 136 associated with the fourth document processing device 134, or via the user devices 144, 148, or 152, credential data is received by the document processing device 134 from the associated user 156. It will be appreciated by those skilled in the art that such communication is capable of originating via wired or wireless channels from the user devices 144, 148, or 152 to the document processing device 134, via input by the user 156 of login data at the user interface 136 associated with the document processing device 134, or the like.

The received credential data is then communicated from the recipient document processing device 134 to the authentication device 104 in accordance with the previously received address data. The authentication device 104 then retrieves the user key associated with the credential data stored on the data storage device 110. The credential data is then tested against the received credential data by the authentication device 104. It will be appreciated by those skilled in the art that the testing includes, for example and without limitation, comparisons of decrypted user key data with received credential data, or the like. The authentication device 104 then attempts to authenticate the user 156 based upon the received credential data as tested against the stored user key. When the authentication device 104 determines that the user 156 cannot be authenticated, the user 156 is denied access to document processing operations via the fourth document processing device 134. When the authentication device 104 determines that the user 156 has been authenticated, authorization data is communicated from the authentication device 104 to the fourth document processing device 134. The authorization data thereby enables the user 156 to perform at least one document processing operation upon the completed user authentication at the fourth document processing device 134.

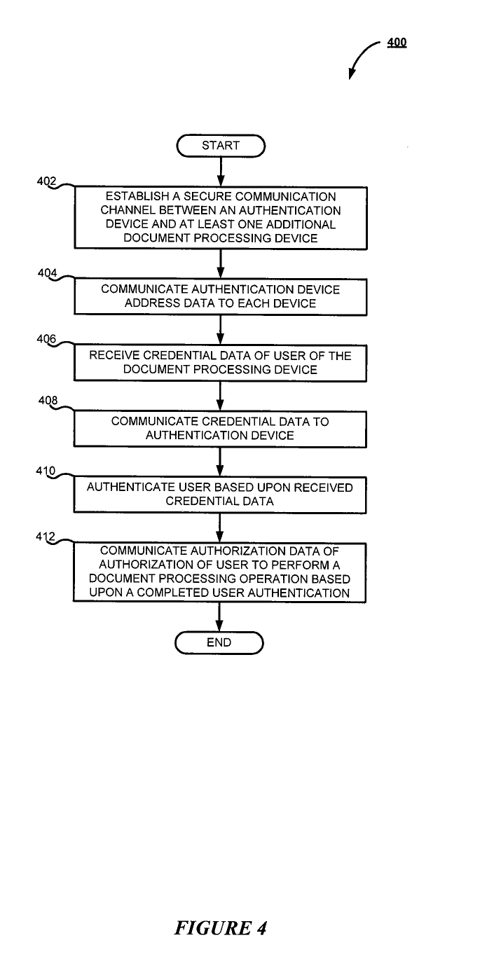

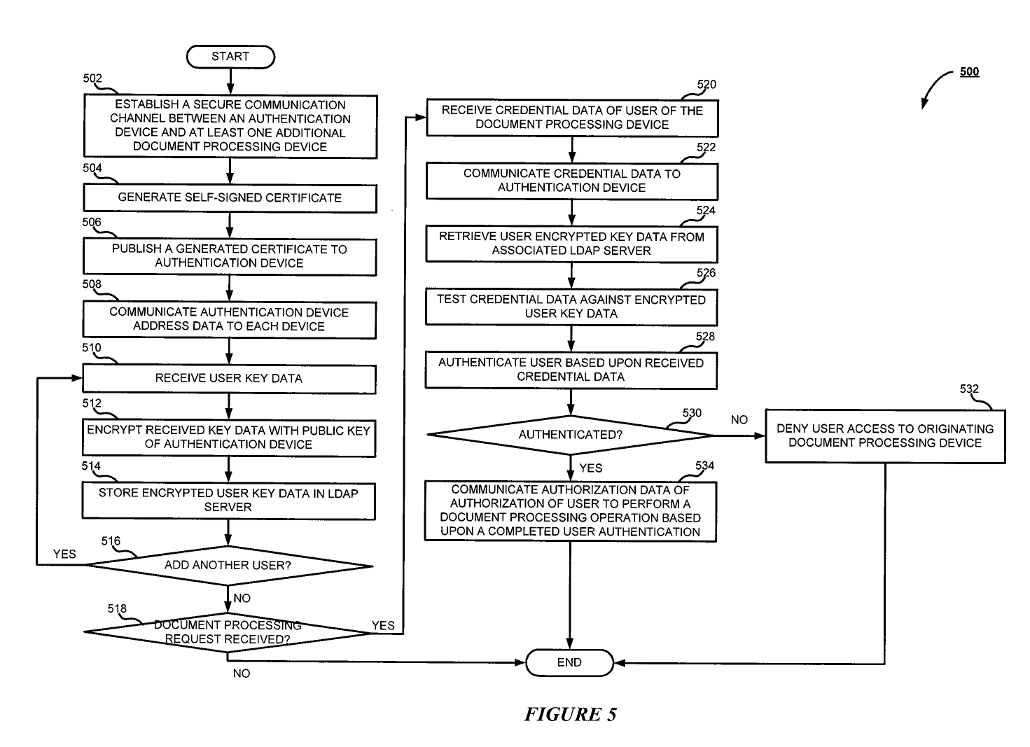

The skilled artisan will appreciate that the subject system 100 and components described above with respect to FIG. 1, FIG. 2, and FIG. 3 will be better understood in conjunction with the methodologies described hereinafter with respect to FIG. 4 and FIG. 5. Turning now to FIG. 4, there is shown a flowchart 400 illustrating a method for centralized user identification for networked document processing devices in accordance with one embodiment of the subject application. Beginning at step 402, an authentication device and at least one additional document processing device of a plurality of document processing devices establish a secure communications channel. For example purposes only, reference is made hereinafter to the first document processing device 104 being designated as the authentication device and the at least one additional document processing device is the fourth document processing device 134. The skilled artisan will appreciate that each of the document processing devices 104, 114, 124, and 134 include a corresponding controller 108, 118, 128, and 138, which has at least one document rendering device associated therewith. Those skilled in the art will further appreciate that the authentication device is capable of being designated as any one of the document processing devices 104, 114, 124, or 134.

At step 404, authentication device 104 address data, such as a uniform resource locator (URL), Internet Protocol (IP) address, or the like, is then communicated to the document processing devices 114, 124, and 134 via the computer network 102. Credential data of the user 156 associated with the fourth document processing device 134 is then received by the authentication device 104 via the computer network 102 at step 406. In accordance with one embodiment of the subject application, the credential data is received from the user 156 via one of the user devices 144, 148, or 152. That is, the credential data is communicated, via a wired communications cable or wirelessly, to any of the additional document processing devices 114, 124, or 134. For example purposes only, the credential data is communicated to the fourth document processing device 134. The credential data is then communicated, at step 408, from the recipient document processing device, e.g., the fourth document processing device 134, to the authentication device 104 via the computer network 102.

The authentication device 104 then authenticates the user based upon the received credential data at step 410. Thereafter, the authentication device 104, via the computer network 102, communicates authorization data to the fourth document processing device 134 corresponding to an authorization of the user 156 with respect to the fourth document processing device 134. Thus, the user 156 is thereby authorized, via step 410, to perform at least one document processing operation upon a completed user authentication.

Referring now to FIG. 5, there is shown a flowchart 500 illustrating a method for centralized user identification for networked document processing devices in accordance with one embodiment of the subject application. The methodology illustrated in FIG. 5 begins at step 502, whereupon a secure communications channel is established between an authentication device, i.e., one of the document processing devices 104, 114, 124, and 134 on the computer network 102 designated as an authentication device, and at least one additional document processing device 104, 114, 124, or 134. For example purposes only, and with respect to FIG. 5, the first document processing device 104 is designated as the authentication device. The at least one additional document processing device is designated hereinafter, for example purposes, as the fourth document processing device 134. It will be apparent to those skilled in the art that the number of additional document processing devices is referenced as three devices 114, 124, and 134 for example purposes only, and any number of document processing devices are capable of employing the method described in FIG. 5. At step 504, the at least one additional document processing device 134 generates a self-signed certificate. The self-signed certificate is then published, at step 506, to the authentication device 104 via the computer network 102.

At step 508, the authentication device 104 communicates address data associated with the authentication device 104 to each of the additional document processing devices 114, 124, and 134 in data communication via the computer network 102. In accordance with one embodiment of the subject application, the address data includes, for example and without limitation, a uniform resource locator (URL), an Internet Protocol (IP) address, or the like. It will be understood by those skilled in the art that the published certificate is thereafter stored via an LDAP directory, on the data storage device 110 associated with the authentication device 104.

At step 510, user key data is received by the at least one additional document processing device, e.g., the fourth document processing device 134. That is, a symmetric key associated with the user 156 is received by the fourth document processing device 134 from an associated user device 144, 148, or 152, via a portable storage medium accessed by the fourth document processing device 134, or the like. In accordance with one particular embodiment of the subject application, the controller 138 associated with the fourth document processing device 134 is capable of generating symmetric keys for the user 156 based upon data input by the user 156 via the associated user interface 136. At step 512, the fourth document processing device 134 encrypts the user symmetric keys using a public key associated with the authentication device 104, which is known to the fourth document processing device 134 in accordance with the received address data. The encrypted key is then communicated to the authentication device 104, whereupon it is stored at step 514 in the data storage device 110, preferably within an LDAP server or directory. A determination is then made at step 516 whether the fourth document processing device 134 has received any additional user information, e.g., whether any additional users have attempted to access the fourth document processing device 134. Upon a positive determination, flow returns to step 510, whereupon user key data is received for the additional user and operations continue as set forth above.

When no additional user information is detected, flow proceeds to step 518, whereupon a determination is made whether a document processing request has been received by the fourth document processing device 134. It will be appreciated by those skilled in the art that the document processing request is capable of including, for example and without limitation, document data, user identification or logon data, and the like. It will also be understood by those skilled in the art that such a document processing request is capable of originating from a user device 144, 148, or 152, via direct user interaction with the document processing device 134, or the like. When no document processing requests have been received, the method described in FIG. 5 terminates, awaiting the receipt of additional users or a suitable document processing request.

When a document processing request has been received from the user, flow proceeds to step 520, whereupon user credential data is received by the document processing device 134 from the associated user 156. It will be appreciated by those skilled in the art that such communication is capable of originating via wired or wireless channels from the user devices 144, 148, or 152 to the document processing device 134, via input by the user 156 of login data at the user interface 136 associated with the document processing device 134, or the like.

The fourth document processing device 134 then communicates, at step 522, the received credential data to the authentication device 104 based upon the previously received address data. At step 524, the authentication device 104 retrieves the user key associated with the credential data stored in the LDAP directory on the data storage device 110. The authentication device 104 then tests the credential data against the received credential data at step 526. It will be appreciated by those skilled in the art that the testing includes, for example and without limitation, comparisons of decrypted user key data with received credential data, or the like. An authentication of the user 156 is then attempted by the authentication device 104 at step 528, in accordance with the output of the test of credential data and the stored user key data. A determination is then made by the authentication device 104 at step 530 whether or not the user 156 has been authenticated. Upon a negative determination at step 530, flow proceeds to step 532, whereupon the user 156 is denied access to the resources of the fourth document processing device 134. Upon a determination that the user 156 has been successfully authenticated, flow proceeds to step 534, whereupon authorization data, corresponding to authorization of the user 156 to perform one or more document processing operations is communicated to the fourth document processing device 134 by the authentication device 104. Thereafter, the fourth document processing device 134 is capable of performing the document processing operations associated with the received document processing request.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A centralized user identification system for networked document processing devices comprising:
a plurality of document processing devices, each document processing device including a controller having at least one document rendering device associated therewith, wherein one document processing device is designated as an authentication device;
securing means adapted for establishing a secure data communication channel between the authentication device and at least one additional document processing device of the plurality thereof;
means adapted for communicating address data associated with the authentication device to each at least one additional document processing device;
means adapted for receiving credential data associated with a user of the at least one document processing device;
means adapted for communicating received credential data from the at least one document processing device to the authentication device in accordance with address data;
the authentication device including authentication means adapted for authenticating the user of the at least one document processing device in accordance with received credential data; and
means adapted for communicating authorization data representative of authorization of the user to perform at least one document processing operation on the at least one document processing device in accordance with a completed authentication from the authentication device to the at least one document processing device.

2. The system of claim 1 wherein the securing means includes:
means adapted for generating a self-signed certificate on the at least one additional document processing device; and
means adapted for publishing a generated certificate to the authentication device.

3. The system of claim 1 wherein the authentication means includes:
means adapted for receiving user key data from the user;
means adapted for encrypting received user key data with a public key associated with the authentication means;
storage means adapted for storing encrypted user key data; and
testing means adapted for testing credential data against encrypted user key data disposed in the storage means in accordance with an authentication.

4. The system of claim 3 wherein the storage means is comprised of an LDAP server.

5. The system of claim 1 wherein the address data is comprised of at least one of the group consisting of an IP address and a URL associated with the authentication device.

6. The system of claim 1 wherein the credential data is received from at least one device from a set comprising a workstation, a smart phone, and a personal digital assistant, and which credential data is communicated via at least one of a wireless and wired communication medium.

7. A method for centralized user identification for networked document processing devices comprising the steps of:
establishing a secure data communication channel between an authentication device and at least one additional document processing device of a plurality of document processing devices, each document processing device including a controller having at least one document rendering device associated therewith, wherein one document processing device is designated as the authentication device;
communicating address data associated with the authentication device to each at least one additional document processing device;
receiving credential data associated with a user of the at least one document processing device;
communicating received credential data from the at least one document processing device to the authentication device in accordance with address data;
authenticating the user of the at least one document processing device in accordance with received credential data; and
communicating authorization data representative of authorization of the user to perform at least one document processing operation on the at least one document processing device in accordance with a completed authentication from the authentication device to the at least one document processing device.

8. The method of claim 7 wherein the step of establishing a secure data communication channel includes the steps of:
generating a self-signed certificate on the at least one additional document processing device; and
publishing a generated certificate to the authentication device.

9. The method of claim 7 wherein the step of authenticating the user includes the steps of:
receiving user key data from the user;
encrypting received user key data with a public key associated with the authentication device;
storing encrypted user key data in an associated storage; and
testing credential data against encrypted user key data disposed in the associated storage in accordance with an authentication.

10. The method of claim 9 wherein the associated storage is an LDAP server.

11. The method of claim 7 wherein the address data is comprised of at least one of the group consisting of an IP address and a URL associated with the authentication device.

12. The method of claim 7 wherein the credential data is received from at least one device from a set comprising a workstation, a smart phone, and a personal digital assistant, and which credential data is communicated via at least one of a wireless and wired communication medium.

13. A computer-implemented method for centralized user identification for networked document processing devices comprising the steps of:
establishing a secure data communication channel between an authentication device and at least one additional document processing device of a plurality of document processing devices, each document processing device including a controller having at least one document rendering device associated therewith, wherein one document processing device is designated as the authentication device;
communicating address data associated with the authentication device to each at least one additional document processing device;
receiving credential data associated with a user of the at least one document processing device;
communicating received credential data from the at least one document processing device to the authentication device in accordance with address data;
authenticating the user of the at least one document processing device in accordance with received credential data; and
communicating authorization data representative of authorization of the user to perform at least one document processing operation on the at least one document processing device in accordance with a completed authentication from the authentication device to the at least one document processing device.

14. The computer-implemented method of claim 13 wherein the step of establishing a secure data communication channel includes the steps of:
generating a self-signed certificate on the at least one additional document processing device; and
publishing a generated certificate to the authentication device.

15. The computer-implemented method of claim 13 wherein the step of authenticating the user includes the steps of:
receiving user key data from the user;
encrypting received user key data with a public key associated with the authentication device;
storing encrypted user key data in an associated storage; and
testing credential data against encrypted user key data disposed in the associated storage in accordance with an authentication.

16. The computer-implemented method of claim 15 wherein the associated storage is an LDAP server.

17. The computer-implemented method of claim 13 wherein the address data is comprised of at least one of the group consisting of an IP address and a URL associated with the authentication device.

18. The computer-implemented method of claim 13 wherein the credential data is received from at least one device from a set comprising a workstation, a smart phone, and a personal digital assistant, and which credential data is communicated via at least one of a wireless and wired communication medium..
